(19) United States
(12) Patent Application Publication
(10) Pub. No.: US 2002/0124010 A1
(43) Pub. Date: Sep. 5, 2002

(54) Design system based on design options with shared data base

(76) Inventors: Joong-Ki Park, Taejon (KR); Sung-Bae Han, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/820,350

(22) Filed: Mar. 29, 2001

(30) Foreign Application Priority Data
Dec. 28, 2000 (KR) 2000-83418

(51) Int. Cl. G06F 12/00

(52) U.S. Cl. 707/200

(57) ABSTRACT

A design system based on design options with a shared data base is disclosed. Further, a method therefor and a recording medium are disclosed. A computer-aided design system (CAD) is made to be interlocked to a data management system, so that the productivity aggravation due to the low efficiency and errors in manually carrying out the preparation of the drawings, in the raw material calculation and in the price calculation can be avoided, and that the productivity of the automatic design can be improved. A product design means stores a reference design data, and carries out an actual drawing of a pattern in accordance with the reference design data. A data management means manages a data for design options, transmits a design specification data to the product design means, and receives various data from the product design means so as to manage them. A data matching means shares the design data of both the product design means and the data management means.

### FIELD OF THE INVENTION

The present invention relates to a design system based on design options with a shared database. More specifically, the present invention relates to a design system based on design options with a shared data base, and also relates to a method therefor and a recording medium, in which the computer aided design system (CAD) is made to be interlocked to the data management system, so that the productivity aggravation due to the low efficiency and errors in manually carrying out the preparation of the drawings, the raw material calculation and the price calculation can be avoided, and that the productivity of the automatic design can be improved.

### BACKGROUND OF THE INVENTION

Coming recently, the domestic enterprising environment is being rapidly changing due to the liberalization, the globalization and the diversification of the consumer demands. Further, in order to meet the deepening competitions, the small quantity orders and the diversified consumer desires, there is required a speedier and more accurate response. This situation leads to a demand that the time period for carrying out the design has to be shortened, and consequently that the design operation management efficiency has to be maximized.

Recently, owing to the development of high performance computers and the progress in the software, the industrial field constructed a new computing system by investing large amounts of money in the facility and education so as to overcome the low efficiency due to the manual works. However, compared with the amount of the investment, the reaped result has been meager.

Particularly, in the manufacturing field, the dependence on the personal experience and skill has to be decreased, the overlapping of the works has to be decreased, and the productions have to be carried out in a comprehensive manner, so that the errors can be minimized.

Presently, the design, the material calculation and the production are of the ordered type, and therefore, the design specifications are altered at every order, with the result that the optimum material selection and the optimum component selection become difficult. Further, the cost for the design operation becomes difficult.

### SUMMARY OF THE INVENTION

The present invention is intended to overcome the above-described disadvantages of the conventional technique.

Therefore it is an object of the present invention to provide a design system based on design options with a shared data base, a method for realizing the system and a recording medium therefor, in which the computer-aided design system (CAD) is made to be interlocked to the data management system, so that the productivity aggravation due to the low efficiency and errors in manually carrying out the preparation of the drawings, in the raw material calculation and the in price calculation can be avoided, and that the productivity of the automatic design can be improved.

In accordance with an aspect of the present invention, there is provided a design system based on design options with a shared database, comprising: a product design means for storing a reference design data, and for carrying out an actual drawing of a pattern in accordance with the reference design data; a data management means for managing a data for design options, for transmitting a design specification data to the product design means and for receiving various data from the product design means so as to manage them; and a data matching means for sharing the design data of both the product design means and the data management means.

In accordance with another aspect of the present invention, there is provided a design method applied to a design system with a shared data base, comprising: a first step of loading an application program, for setting a channel; a second step of requesting for a design data through the channel to a data management system to receive it, and for calculating a position for a product design based on the design data thus received; a third step of checking as to whether the position thus calculated is an optimum one; a fourth step of requesting for the design data of the second step again if it is found not an optimum one at the third step; and a fifth step of carrying out a product design if it is an optimum one at the third step, transmitting the optimum design data to the data management system to store it and output it, and terminating the application program.

In accordance with still another aspect of the present invention, there is provided a design method applied to a design system with a shared data base, comprising: a first step of receiving a design specification, selecting a material, transmitting the design data through a channel, and receiving the design data from a computer-aided design system; a second step of checking as to whether the transmitted and received design data has been modified; a third step of selecting the material again if the design data has been modified at the second step; a fourth step of changing the material if there has been no modification of the design data at the second step, calculating a BOM (bill of material), preparing a report, and checking as to whether the channel has been closed; and a fifth step of storing and outputting a relevant file if the channel has been closed at the fourth step, and transmitting and receiving the design data like at the first step if the channel has not been closed.

In accordance with still another aspect of the present invention, there is provided a computer-readable medium involving a large scale processor, comprising the functions of: loading an application program, for setting a channel; requesting for a design data through the channel to a data management system to receive it, and for calculating a position for a product design based on the design data thus received; checking as to whether the position thus calculated is an optimum one; requesting for the design data of the second step again if it is found not an optimum one at the third step; and carrying out a product design if it is an optimum one at the third step, transmitting the optimum design data to the data management system to store it and output it, and terminating the application program.

In accordance with still another aspect of the present invention, there is provided a computer-readable medium involving a large scale processor, comprising: a first function of receiving a design specification, selecting a material, transmitting the design data through a channel, and receiving the design data from a computer-aided design system; a second function of checking as to whether the transmitted and received design data has been modified; a third function of selecting the material again if the design data has been modified at the second function; a fourth function of changing the material if there has been no modification of the design data at the second function, calculating a BOM (bill of material), preparing a report, and checking as to whether the channel has been closed; and a fifth function of storing and outputting a relevant file if the channel has been closed at the fourth function, and transmitting and receiving the design data like at the first function if the channel has not been closed.

### BRIEF DESCRIPTION OF THE DRAWINGS

The above object and other advantages of the present invention will become more apparent by describing in detail the preferred embodiments of the present invention with reference to the attached drawings in which:

FIG. 1 illustrates the constitution of the computer-aided design system according to the present invention; and

FIG. 2 is a flow chart showing the operation of the computer-aided design system according to the present invention.

### DESCRIPTION OF THE PREFERRED EMBODIMENT

First, the background elements for the present invention will be described. That is, upon analysis of the various design operations, the following facts have been found. That is, in the designs based on orders, the computer-aided design system (CAD) is most widely used, and the data managements are mostly carried out by the splashed program (e.g., excel). Therefore, if these two factors are correlatively used, then the estimation report based on the specification can be inputted, and the various drawings can be automatically drawn, thereby drastically improving the processing time. If this design is approved, then an automatic design system can be realized down to the component design based on the standard.

The raw materials can be calculated directly from the automatically drawn drawings, and the BOM (bill of material) can be automatically calculated, whereby the product manufacturing cost can be instantly computed so as to improve the total operation efficiency including the product order and the production.

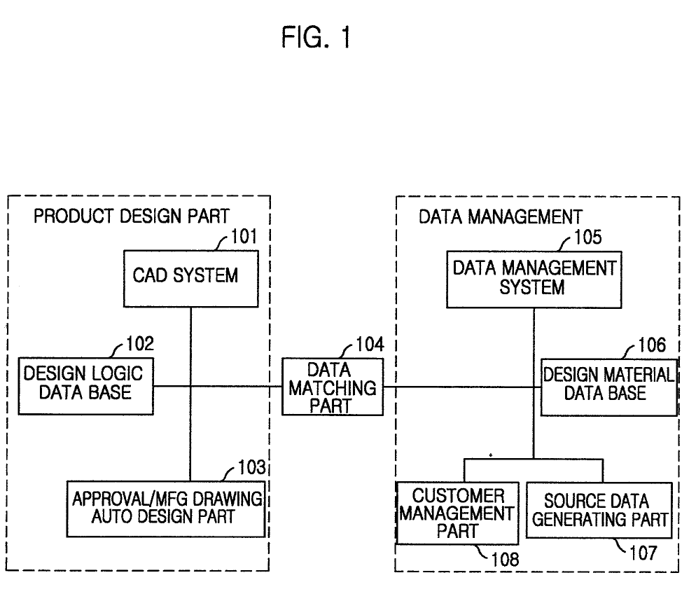

FIG. 1 illustrates the constitution of the computer-aided design system according to the present invention.

As shown in FIG. 1, the product design system with the shared database roughly includes: a product designing part, and a data management part. The product designing part includes: a computer-aided design system (autoCAD) 101 for carrying out an actual drawing of a pattern related to a product design; a design logic data base 102 for storing a data for the design by the computer-aided design system 101; and an approval/ drawing automatic designing part 103 for preparing the drawings to be approved or to be used for manufacture.

The data management part includes: a data management system (e.g., excel) 105 for managing a data base based on the BOM (bill of material) and the material calculation; a design material data base 106 for storing an updated material calculation data as managed by the data management system; a customer managing part 108 for managing sales and receipts and a customer order information; and a source data generating part 107 for generating a source data for making it possible to manage the data base by the data management system based on a processed data of the customer managing part.

Meanwhile, data exchanges should be possible between the product designing part and the data managing part, and therefore, the design data have to be shared between the constituents of the product designing part and the constituents of the data managing part.

Now the product design system with the shared database according to the present invention will be described as to its major functions.

The major functions include: the preparation of an estimation specification based on the ordered specification; an automatic designing of the drawings to be approved based on the inputted design specification; drawing a production drawing based on the approved specification data; an automatic calculation of a BOM (bill of material); and carrying out an integral design management through the internet.

Of the above-described major functions, first the automatic calculation of a BOM (bill of material) will be described. That is, the designed material can be calculated, and the cost can be managed. At the designing part, the automatic drawing preparation can be carried out by utilizing the computer-aided design system (CAD) 101, and upon having carried out this task, the material cost can be calculated to provide a pre-cost.

Further, the material procurement list can be formed based on the material list of the designing part, and a procurement situation table for the items procured from external sources can be managed.

Of the major functions, the operations related to the approved drawings will be described. That is, if the ordered specification is inputted to the data management system 105, then the data management system 105 selects the various materials suiting to the specification, and in accordance with the needs, the designer adds some tuning. Then data exchanges become possible between the computer-aided design system 101 and the data management system 105.

If the data management system 105 modifies the design specification, then the computer-aided design system 101 applies it as it is. Then the updated design specification is transmitted to the data matching part 104 by which a system capable of integrally preparing the drawing is constructed.

The input/output relations of the approved drawings can be summarized as shown in Table 1 below.

TABLE 1

| Functions | Input | Output |
|---|---|---|
| Ordered spec is | Capacity, size, | Material details |
| put to data base | material kind | Calculation formula |
| Approved drawing | Cylinder type, | Assembled drawing |
| auto designing | upper plate support ratio | |
| Immediate modifi- | Special specification is | |
| cation impossible | decided > Spec. | |

The manufacturing drawings are prepared based on the specification of the approved drawings.

Meanwhile, regarding to the calculation of the BOM (bill of material), the various material details are prepared based on the approved drawings and the manufacturing drawings. These are connected to the BOM, so that the unit price of the product can be immediately calculated.

Now the function of the customer management will be described. That is, the order details and their proceeding situation can be integrally managed through the internet so as for the information to be shared, while the design specifications and the design situation can be intensively managed. Thus the design and production situations can be integrally managed by the designing department, so that the overall operating system can be constructed.

If the materials of the components are automatically calculated, then the design cost can be directly calculated, and the orders can be directly handled, thereby improving the business efficiency.

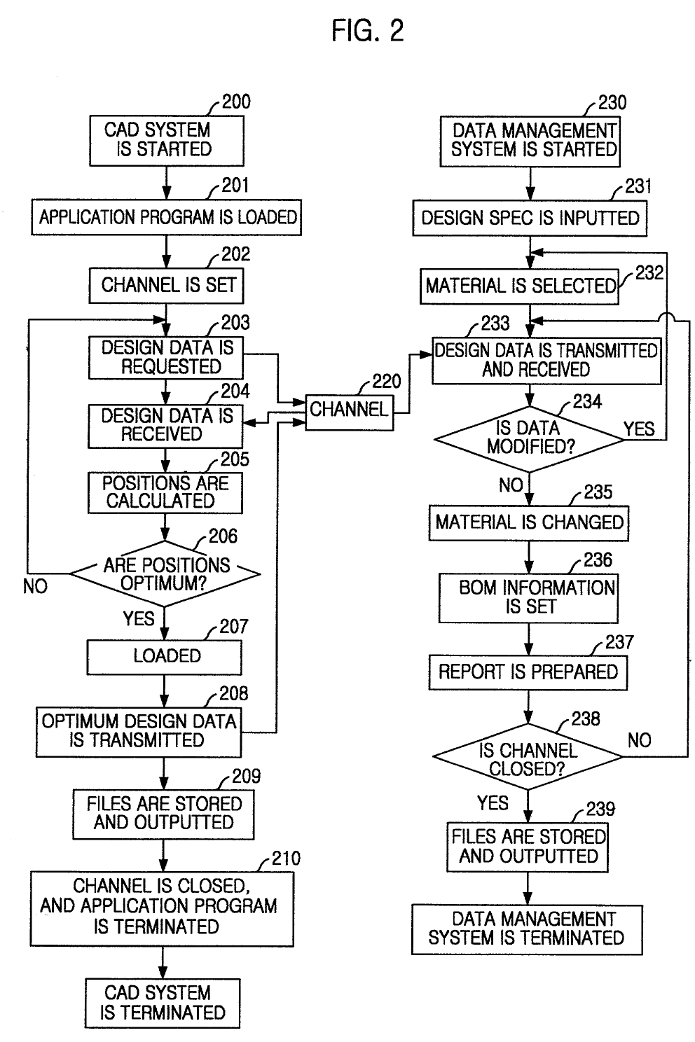

FIG. 2 is a flow chart showing the operation of the design system with the shared database according to the present invention.

As shown in FIG. 2, the computer-aided design system and the data management system operate in an interlocked manner at steps 200 and 230, and thereafter, the computer-aided design system loads the application program (TL, ARX) at step 201, while the data management system receives the designed specification of the designer or of the ordered person at the environment of the data management system at step 231.

Under this condition, for the sake of the data transmission and reception to and from the data management system, the computer-aided design system opens a channel 220 for exchanging the system operation data with the data matching part at step 202. Further, the data management system selects the materials in accordance with the mentioned specification, and then, transmits or receives the design data to or from the computer-aided design system.

Further, a judgment is made as to whether the design data thus transmitted or received has been modified. If the data has been modified, the material selecting procedure 232 is carried out, while if there has been no modification, then the material is changed at step 235, a BOM information is calculated at step 236, and a report is prepared based on the calculated BOM (bill of material) at step 237.

Thereafter, a judgment is made as to whether the channel 220 is to be closed at step 238. If the channel 220 is to be closed, then the files which have been accumulated up to the present are stored and outputted at step 239, while if the channel is not to be closed, then the system advances to the step 233 at which the data is transmitted or received.

In connection with the operation of the data management system, the computer-aided design system requests for the design data through the channel 220 to the data management system at step 203 after the channel 220 has been set at step 202. Then the computer-aided design system receives the design data for the product design from the data management system at step 204. That is, in response to the above-mentioned request, the computer-aided design system receives the data from the data management system.

Upon receipt of the design data, the positions of the respective portions are decided for designing the product at step 205, and a judgment is made as to whether the calculated positions are the optimum ones at step 206.

Upon the judgment, if it is found that the calculated positions are not the optimum ones, then the system advances to the step 203 at which the design data is requested. On the other hand, if it is found that the optimum positions have been calculated, then the product designing is carried out based on the calculated positions at step 207.

Upon completion of the drawings, the optimum design data is transmitted to the data management system at step 208.

Thereafter, the files which have been generated up to the present are stored and outputted at step 209, the channel 220 is closed, and the application program is terminated.

The above procedures can be summarized as follows.

First, at a status in which the main picture shows the data management system, if the specification is decided, then the main picture is shifted to the computer-aided design system to output a drawing command. Thus the design data is inputted through a communication channel, and thus, the drawings are automatically drawn.

Accordingly, the processing details of the data management system are such that the various materials are automatically selected based on the design specification, and the design data is received from the computer-aided design system, thereby forming a BOM (bill of material).Further, the computer-aided design system reads the various processed design data, and thus the assembling drawings and the manufacturing drawings are automatically drawn, and the design data is returned to the data management system again.

In the method of the present invention as described above, the constitution of the method is formed into a program which can be read by the recording medium such as CD ROM, RAM, ROM, floppy disk, hard disk, or optico-magnetic disk which can be read by a computer.

In the above, the present invention was described based on the specific preferred embodiment and the attached drawings, but it should be apparent to those ordinarily skilled in the art that various changes and modifications and substitutions can be added without departing from the spirit and scope of the present invention, which will be defined in the appended claims.

According to the present invention as described above, the drawings are automatically drawn from the reception of the ordered specification down to the manufacturing design based on the analyzed design operation and on the coherent operating system. Based on this procedure, the BOM (bill of material) information is automatically extracted, with the result that the production cost and the material requirements can be automatically calculated.

What is claimed is:

1. A design system based on design options with a shared data base, comprising:
a product design means for storing a reference design data, and for carrying out an actual drawing of a pattern in accordance with the reference design data;
a data management means for managing a data for design options, for transmitting a design specification data to the product design means and for receiving various data from the product design means so as to manage them; and
a data matching means for sharing the design data of both the product design means and the data management means.

2. The design system as claimed in claim 1, wherein said product designing part comprises:
a computer-aided design system for carrying out an actual drawing of a pattern related to a product design;
a design logic storing means for storing a data for the design by the computer-aided design system; and
an approval/drawing automatic designing part for preparing the drawings to be approved or to be used for manufacture.

3. The design system as claimed in claim 1, wherein said data management part comprises:
a data management system for managing a data base based on the BOM (bill of material) and a material calculation;
a design material data storing means for storing an updated material calculation data as managed by the data management system;
a customer managing means for managing sales and receipts and an information on customer orders; and
a source data generating means for generating a source data for making it possible to manage the data base by the data management system based on a processed data of the customer managing means.

4. A design method applied to a design system with a shared data base, comprising:
a first step of loading an application program, for setting a channel;
a second step of requesting for a design data through the channel to a data management system to receive it, and for calculating a position for a product design based on the design data thus received;
a third step of checking as to whether the calculated position is optimum;
a fourth step of requesting for the design data of the second step again if it is found not an optimum one at the third step; and
a fifth step of carrying out a product design if it is an optimum one at the third step, transmitting the optimum design data to the data management system to store it and output it, and terminating the application program.

5. A design method applied to a design system with a shared data base, comprising:
a first step of receiving a design specification, selecting a material, transmitting the design data through a channel, and receiving the design data from a computer-aided design system;
a second step of checking as to whether the transmitted and received design data has been modified;
a third step of selecting the material again if the design data has been modified at the second step;
a fourth step of changing the material if there has been no modification of the design data at the second step, calculating a BOM (bill of material), preparing a report, and checking as to whether the channel has been closed; and
a fifth step of storing and outputting a relevant file if the channel has been closed at the fourth step, and transmitting and receiving the design data like at the first step if the channel has not been closed.

6. A computer-readable medium involving a large scale processor, comprising the functions of:
loading an application program, for setting a channel;
requesting for a design data through the channel to a data management system to receive it, and for calculating a position for a product design based on the design data thus received;
checking as to whether the position thus calculated is an optimum one;
requesting for the design data of the second step again if it is found not an optimum one at the third step; and
carrying out a product design if it is an optimum one at the third step, transmitting the optimum design data to the data management system to store it and output it, and terminating the application program.

7. A computer-readable medium involving a large scale processor, comprising:
a first function of receiving a design specification, selecting a material, transmitting the design data through a channel, and receiving the design data from a computer-aided design system;
a second function of checking as to whether the transmitted and received design data has been modified;
a third function of selecting the material again if the design data has been modified at the second function;
a fourth function of changing the material if there has been no modification of the design data at the second function, calculating a BOM (bill of material), preparing a report, and checking as to whether the channel has been closed; and
a fifth function of storing and outputting a relevant file if the channel has been closed at the fourth function, and transmitting and receiving the design data like at the first function if the channel has not been closed.
